(19) United States
(12) Patent Application Publication
(10) Pub. No.: US 2017/0093095 A1
(43) Pub. Date: Mar. 30, 2017

(54) TRANSMISSION LINE FOR ELECTRONIC APPARATUS

(71) Applicant: AEVOE INTERNATIONAL LTD., Tortola (VG)

(72) Inventors: Shen Fu CHIN, Taipei City (TW); Wang Chung CHIEN, Keelung City (TW); Jen Shau DONG, Kaohsiung City (TW)

(73) Assignee: AEVOE INTERNATIONAL LTD., Tortola (VG)

(21) Appl. No.: 15/006,859

(22) Filed: Jan. 26, 2016

(30) Foreign Application Priority Data
Sep. 24, 2015 (TW) 104131540

(51) Int. Cl. H01R 13/717; H01R 24/64; H02J 7/00; H01R 12/70

(52) U.S. Cl. CPC H01R 13/717; H01R 12/7076; H01R 24/64; H02J 7/0042; H02J 7/0047; H01R 2107/00

(57) ABSTRACT

A transmission line for connecting an electronic apparatus and displaying a charging status of the electronic apparatus includes a first connector for connecting the electronic apparatus, the first connector including a display module to display the charging status of the electronic apparatus, a second connector for connecting a power source, and a line body, including two terminals coupled to the first connector and the second connector respectively, for transmitting the power source to the electronic apparatus for charging, wherein the first connector is a Type-C connector.

### PRIORITY

This application claims the benefit of Taiwanese Patent Application No. 104131540, filed Sep. 24, 2015, the disclosure of which is incorporated herein by reference.

### TECHNICAL FIELD

The present disclosure generally relates to a transmission line used for an electronic apparatus, and more particularly to a transmission line that can display the charging status of an electronic apparatus.

### BACKGROUND

With the development of information and communication technologies, portable electronic devices such as mobile phones, smart phones, tablet PCs, e-books and the like have become an indispensable part of people's lives. Therefore, in addition to continuous innovation in performance and functionality, manufacturers of portable electronic devices have also begun to pursue features such as unique appearance and convenient operation. For example, by breaking through the directional limit of traditional transmission lines, USB 3.1 has introduced a newly designed Type-C transmission line. With the advent of the Type-C transmission line, not only can users insert the connector of the Type-C transmission line into a corresponding receptacle in a reversible manner, but the transmission rate through the transmission line can also be efficiently increased to 10 Gbps. Accordingly, accessories which provide additional functionality and usability for Type-C transmission lines have become a target of the industry's efforts.

### SUMMARY

The approaches set forth herein provide a transmission line for connecting an electronic apparatus and displaying the charging status of the electronic apparatus. The transmission line can include a first connector, such as a Type-C connector, for connecting the electronic apparatus, and a second connector for connecting a power source. The transmission line can further include a display module for displaying the charging status of the electronic apparatus and a line body, the line body including two terminals coupled to the first connector and the second connector, respectively, for transmitting power from the power source to the electronic apparatus for charging.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of a transmission line connecting an electronic apparatus in accordance with an exemplary embodiment;

FIG. 2 illustrates a schematic diagram of a transmission line in FIG. 1;

FIG. 3 illustrates an enlarged schematic diagram of a transmission line in accordance with an exemplary embodiment;

FIG. 4 illustrates a schematic diagram of a first connector in accordance with an exemplary embodiment;

FIG. 5 illustrates a schematic diagram of a first connector in in accordance with another exemplary embodiment; and

FIG. 6 illustrates a schematic diagram of a current detection module of the first connector in accordance with an exemplary embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

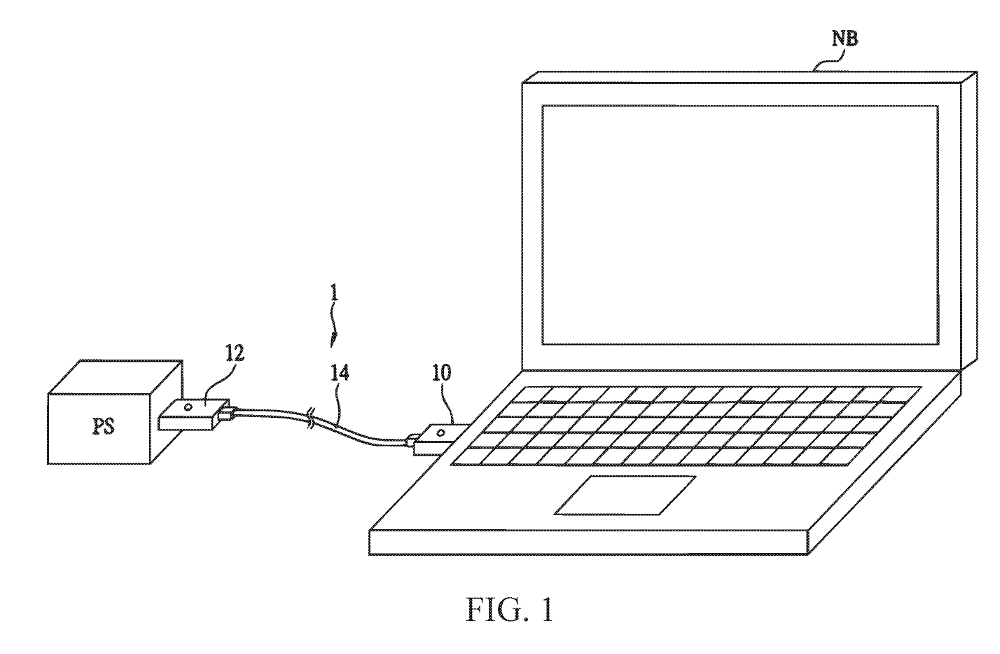

FIG. 1 illustrates a schematic diagram of an electronic apparatus NB connected to a power source PS by a transmission line 1. In this manner, transmission line 1 can provide electronic apparatus NB with power from power source PS. Transmission line 1 can also display the charging status of electronic apparatus NB, such as by displaying that electronic apparatus NB is being charged (i.e., a corresponding status of being charged) or has been charged (i.e., a corresponding status of having been charged). As depicted in FIG. 1, electronic apparatus NB can be a laptop computer. However, electronic apparatus NB is not so limited and can include other devices such as a tablet PC, a smart phone, other electronic devices, and the like.

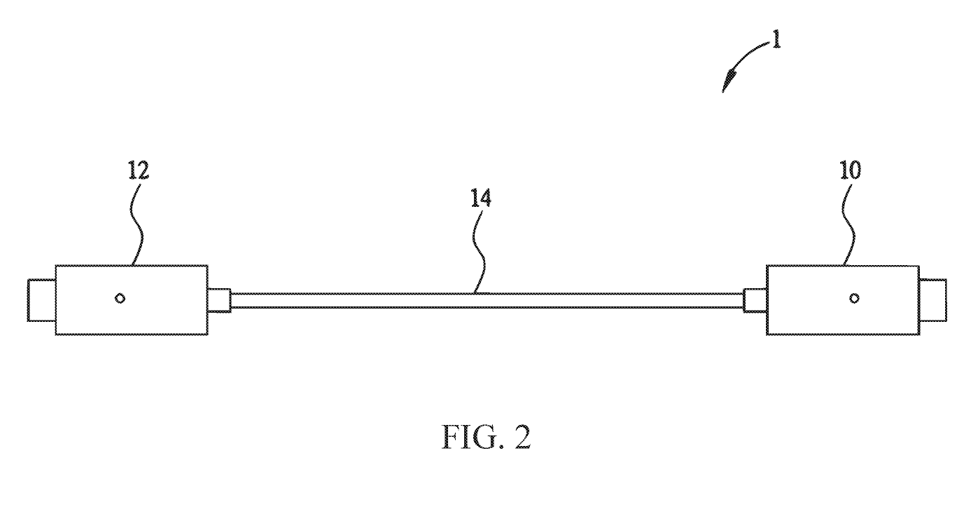

As illustrated in FIG. 2, transmission line 1 can include a first connector 10, a second connector 12 and a line body 14. First connector 10 can be a Type-C connector for connecting to an electronic device (e.g., electronic apparatus NB). Second connector 12 can also be a Type-C connector for connecting to power source, such as power source PS, to receive a stable voltage and/or current. As will be appreciated by those skilled in the art, in other embodiments, first connector 10 and/or second connector 12 can include other connector types such as a USB connector, a mini USB connector, a micro USB connector, a lightning connector, and the like. Line body 14 can include a plurality of wires forming two terminals: a first terminal coupled to first connector 10 and a second terminal coupled to second connector 12. In this manner, the two terminals of transmission line 1 can be coupled to electronic apparatus NB and power source PS via connectors 10 and 12, allowing power from power source PS to be transmitted to electronic apparatus NB for charging.

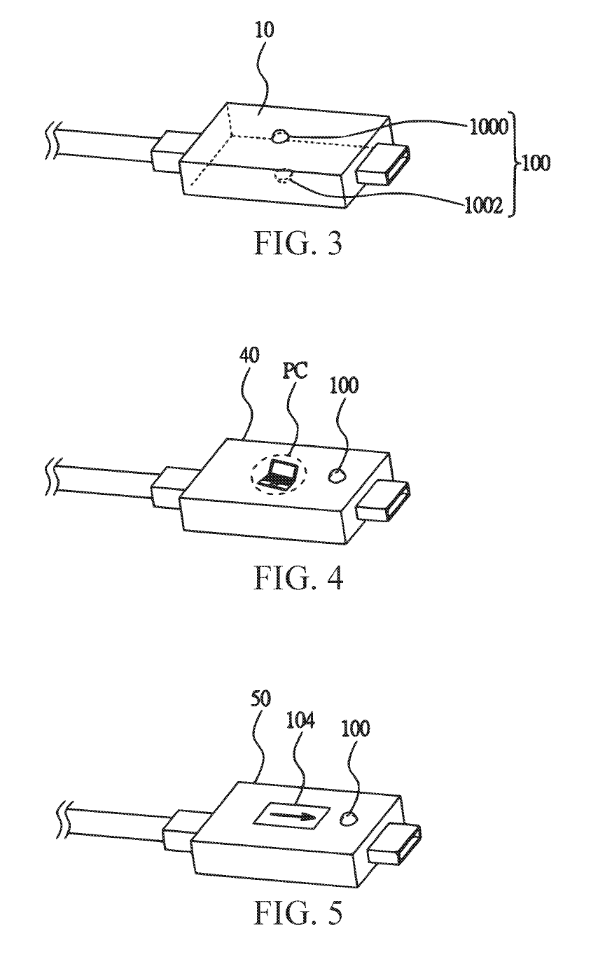

Referring now to FIG. 3, first connector 10 can also include a display module 100 to display the charging status of the electronic apparatus. Display module 100 can include display units 1000 and 1002 arranged on an upper display surface and a lower display surface of first connector 10, respectively. One or more of display units 1000, 1002 can display the current charging status of electronic apparatus NB based on the configuration of first connector 10 after it is inserted into the corresponding receptacle of electronic apparatus NB. For example, if a user inserts first connector 10 into electronic apparatus NB such that the upper display surface is exposed to the user's field of view, at least display unit 1000 can display the current charging status of electronic apparatus NB. On the other hand, if a user inserts first connector 10 into electronic apparatus NB such that the lower display surface is exposed to the user's field of view, at least display unit 1002 can display the current charging status of electronic apparatus NB.

Display units 1000, 1002 of display module 100 can be configured to change their display brightness, display color, display frequency, and the like in any suitable manner to indicate that electronic apparatus NB is being charged or has been charged. For example, display units 1000, 1002 can flicker and/or display a green light to indicate that the electronic apparatus NB has been charged, and can flicker and/or display an orange light to indicate that electronic apparatus NB is being charged. In other cases, display units 1000, 1002 can display a single color and can indicate whether electronic apparatus NB is being charged or has been charged by displaying different brightness levels and/or frequencies. In some cases, display units 1000, 1002 can be configured to indicate different levels of charge of electronic apparatus NB.

First connector 10 can also include a current detection module (not shown) coupled with display module 100. When a user connects electronic apparatus NB to power source PS via transmission line 1, the current detection module can detect the direction of the current flowing through transmission line 1. As a non-limiting example, after transmission line 1 is coupled to electronic apparatus NB and power source PS, transmission line 1 can determine a signal corresponding to each pin of connectors 10 and/or 12 and its mode of operation. From here, transmission line 1 can determine the present current flow with the aid of the current detection module. For instance, when the user connects electronic apparatus NB to power source PS via transmission line 1 to charge electronic apparatus NB, the current detection module can determine that the charging operation enables the current to flow from power source PS to electronic apparatus NB. Display module 100 can then utilize the information from the current detection module to indicate that first connector 10 is connected to electronic apparatus NB and/or display the direction of current flow through transmission line 1.

For example, FIG. 4 illustrates a schematic diagram of transmission line 1 having a first connector 40. When electronic apparatus NB is coupled to first connector 40 of transmission line 1, the display surface of the first connector 40 can display a confirmation icon PC indicating that first connector 40 is coupled to electronic apparatus NB. In addition, FIG. 5 illustrates a schematic diagram of transmission line 1 having a first connector 50. When electronic apparatus NB is coupled to first connector 50 of transmission line 1, the current flows from power source PS to electronic apparatus NB, and the display surface of first connector 50 can display the direction of the current via an indicator unit 104. For example, indicator unit 104 can display an arrow in the direction of the current. However, as will be appreciated by those skilled in the art, confirmation icon PC can use any suitable display to indicate that first connector 40 is coupled to electronic apparatus NB, and indicator unit 104 can utilize any suitable configuration to display the direction of the current.

Once the user couples the connector on either end of transmission line 1 to electronic apparatus NB, the connector can display the charging status of electronic apparatus NB via the display module (e.g., display module 100) and/or the indicator unit (e.g., confirmation icon PC, indicator unit 104, etc.). In addition, second connector 12 coupled to power source PS can also contain a display module (e.g., display module 100), an indicator unit (e.g., confirmation icon PC, indicator unit 104, etc.), and/or a current detection module to display the corresponding charging status of electronic apparatus NB and a direction of current flow. The display module of second connector 12 can include a plurality of display units arranged on an upper display surface and a lower display surface of the second connector, respectively. Further, the second connector can detect the current charging status and its corresponding current flow direction via the current detection module, and can display the charging status and the current flow direction via a plurality of display units and/or indicator modules in accordance with the present disclosure.

In other words, the two connectors of the transmission line 1 (e.g., first connector 10 and second connector 12) can each be equipped with a display module and an indicator unit. Further, the connector coupled to electronic apparatus NB and/or power supply PS can be a Type-C connector for the convenience of the user in the coupling operation. When electronic apparatus NB is being charged, the display module/unit of one or more of the Type-C connectors can display the present charging status (i.e., being charged or having been charged). At the same time, the display module/unit of one or more of the connectors can display the current flow direction corresponding to the charging status. In consideration of different use conditions or operational requirements, the connector coupled to the power source can also adaptively display the present charging status and its corresponding current flow direction in order to help the user determine the charging status of the electronic apparatus, and to prevent the user from carelessly interrupting the charging of the electronic apparatus.

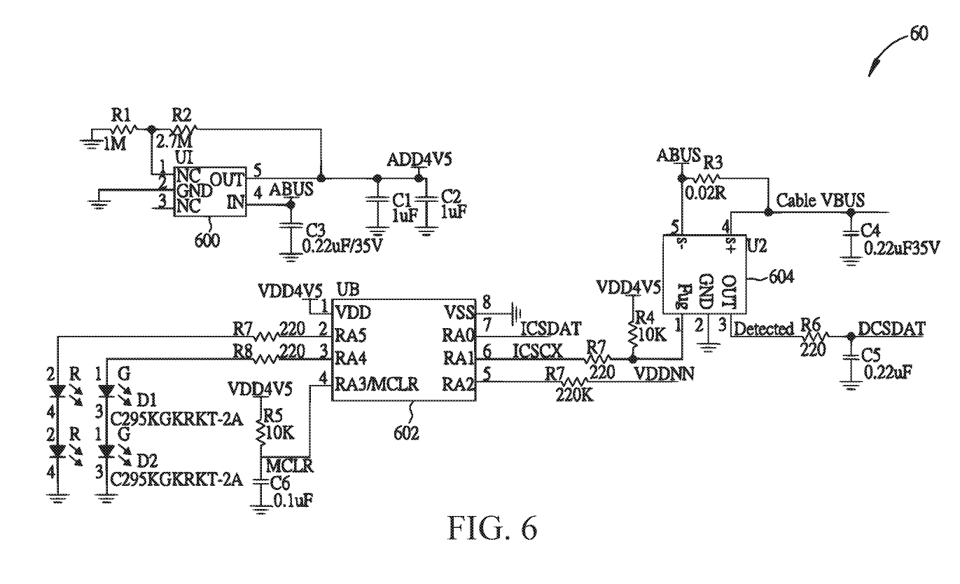

FIG. 6 illustrates a schematic diagram of a current detection module 60 of first connector 10 and/or second connector 12. Current detection module 60 can include modules such as a power restrictor 600, a processing module 602 and a current monitoring module 604. Using these and other modules, current detection module 60 can sense/measure the voltage across and/or current traveling through connectors 10 and/or 12 in order to determine whether the charging operation has been completed. For example, current detection module 60 can set a plurality of electronic components to generate an equivalent resistance, and can use the equivalent resistance during the process of charging to sense/measure the current traveling through and/or the voltage across transmission line 1, first connector 10, and/or second connector 12. Based on the measured voltage and/or current, a control module within or coupled to current detection module 60 can generate different digital or analog signals and can transmit the signals to display units in different branch circuits to indicate (e.g., by display brightness, display color, display frequency, etc.) the charging status of the electronic apparatus. It will be appreciated by those skilled in the art to, based on the embodiment as shown in FIG. 6, combine, modify and/or change the circuit design/implementation to provide different visual effects to indicate the charging status of the electronic apparatus without departing from the scope of the present disclosure.

In summary, the Type-C connectors of the transmission line in accordance with the present disclosure provide convenience for the user in the coupling operation. Furthermore, the connector coupled to the electronic apparatus can include a display module and/or an indicator unit for displaying the present charging status of the electronic apparatus and its corresponding current flow direction. In addition, the connector coupled to the power source can also, depending on different modes of operation, adaptively display the present charging status of the electronic apparatus and its corresponding current flow direction, in order to improve the operation and the convenience of the user. However, the present disclosure is not limited to connecting transmission line 1 and the electronic apparatus NB/power source PS, but can also provide connection to other devices such as common and/or mutually matched male and female slots, or coupling components with electromagnetic induction, etc. Further, although the present disclosure was described in relation to power transfer, one skilled in the art will appreciate that the concepts described herein are applicable data transfer as well.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims. Moreover, claim language reciting “at least one of” a set indicates that one member of the set or multiple members of the set satisfy the claim.

1. A transmission line for connecting an electronic apparatus and displaying a charging status of the electronic apparatus, comprising:
a first connector for connecting to the electronic apparatus, the first connector including a display module to display the charging status of the electronic apparatus, and wherein the first connector is a Type-C connector;
a second connector for connecting to a power source; and
a line body, including a first terminal coupled to the first connector and a second terminal coupled to the second connector, for transmitting the power source to the electronic apparatus for charging.

2. The transmission line of claim 1, wherein the charging status of the electronic apparatus is a status of being charged or a status of having been charged.

3. The transmission line of claim 2, wherein the display module includes a plurality of display units arranged on an upper display surface and a lower display surface of the first connector to display the charging status of the electronic apparatus.

4. The transmission line of claim 2, wherein the display module uses at least one of different display brightness levels, different display colors and different display frequencies to indicate the charging status of the electronic apparatus.

5. The transmission line of claim 2, wherein the first connector includes a current detection module coupled to the display module, the current detection module configured to detect a current flow direction when the electronic apparatus is being charged and to display the current flow direction via the display module.

6. The transmission line of claim 5, wherein the current detection module displays the current flow direction as a pointing direction on the first connector via the display module.

7. The transmission line of claim 1, wherein the second connector includes a current detection module configured to detect a current flow direction when the electronic apparatus is being charged, and a second display module to display the current flow direction.

8. The transmission line of claim 7, wherein the second display module includes a plurality of display units arranged on a display surface of the second connector to display a pointing direction corresponding to the current flow direction.

9. The transmission line of claim 1, wherein the second connector is selected from the group consisting of a USB connector, a USB Type-C connector, a mini USB connector, a micro USB connector and a lightning connector.
